(19) United States
(12) Patent Application Publication
(10) Pub. No.: US 2020/0027158 A1
(43) Pub. Date: Jan. 23, 2020

(54) DISTRIBUTED CONSUMER AUTHENTICATION AND CREDIT OFFER LOCATION

(71) Applicant: Credit One Bank, N.A., Las Vegas, NY (US)

(72) Inventors: Richard William DOMMER, Las Vegas, NV (US); Michael Stuart BROWN, Henderson, NV (US)

(21) Appl. No.: 16/512,141

(22) Filed: Jul. 15, 2019

Related U.S. Application Data
(60) Provisional application No. 62/699,523, filed on Jul. 17, 2018.

(51) Int. Cl. G06Q 40/02; G06F 9/54

(52) U.S. Cl. CPC G06Q 40/025; G06F 9/547

(57) ABSTRACT

A computer system includes a communication circuit configured to communicate over a communication network, a memory, and control circuitry. The control circuitry is configured to generate first interface data for operation at a remote computing terminal over the communication network. The first interface data comprises a first widget configured to receive personal user information. The control circuitry is further configured to receive, via the first widget, a first set of personal user information, generate a first result via comparing the first set of personal user information to a list of users who have been pre-approved to receive an offer, and generate second interface data for operation at the remote computing terminal over the communication network. The second interface data comprises a second widget including an indication of the first result.

### CROSS-REFERENCE TO RELATED APPLICATIONS

This application claims priority to U.S. Provisional Application No. 62/699,523, filed Jul. 17, 2018, and entitled DISTRIBUTED CONSUMER AUTHENTICATION AND CREDIT OFFER LOCATION, the disclosure of which is hereby incorporated by reference in its entirety.

### BACKGROUND

### Field

This disclosure relates to systems and methods for locating and managing offers of credit, such as in the form of credit cards (i.e., “credit offers”). More particularly, the disclosure relates to systems and methods for locating existing credit offers and facilitating consumer applications for credit offers.

### Description of Related Art

Certain credit offer pre-approval solutions can present challenges with respect to, among other things, identifying individuals who have been pre-approved for offers of credit, communicating offer pre-approval status and/or offer terms to the identified individuals, and responding to pre-approved offers by the identified individuals.

### SUMMARY

In accordance with some implementations, the present disclosure relates to a system comprising a communication circuit configured to communicate over a communication network, a memory, and control circuitry configured to generate first interface data for operation at a remote computing terminal over the communication network. The first interface data may comprise a first widget configured to receive user information (e.g., personal user information). The control circuitry is further configured to receive, via the first widget, a first set of user information (e.g., personal user information), generate a first result via comparing the first set of user information (e.g., personal user information) to a list of users who have been pre-approved to receive an offer, and generate second interface data for operation at the remote computing terminal over the communication network. The second interface data may comprise a second widget including an indication of the first result.

In some embodiments, the list of users is stored in the memory. The control circuitry may be further configured to generate an application programming interface (API) request based on the received user information (e.g., personal user information) and send the API request to a remote data store to request a per-user lookup of pre-approved offers. The list of users may be stored in the remote data store. In some embodiments, the control circuitry is further configured to obtain a set of criteria for identifying pre-approved candidates and generating a list of users who have been pre-approved for the offer based on the received set of criteria. The first set of user information (e.g., personal user information) may comprise one or more of a name and a social security number.

In certain embodiments, the first result is indicative of a positive match. In response to the indication of the positive match, the second widget may comprise one or more fields for collecting a second set of personal information. In some embodiments, the control circuitry is further configured to receive, via the second widget, the second set of user information (e.g., personal user information). The second set of personal information may comprise one or more of a name, residential address, e-mail address, and social security number. In some embodiments, the control circuitry is further configured to generate a second result via comparing the second set of user information (e.g., personal user information) to stored user information and generate third interface data for operation at the remote computing terminal over the communication network. The third interface data may comprise a third widget including an indication of the second result.

In some embodiments, the second interface data comprises a hyperlink to one of a first web page for facilitating acceptance of the offer and a second web page for facilitating an application process for a second offer. The control circuitry may be further configured to generate a fraud result based on one or more of a location associated with the first interface data, an internet protocol (IP) address associated with the first interface data, and a determination that the first interface data is identical to one or more previously received interface data sets. In some embodiments, the control circuitry may be further configured to generate the second interface data for operation at the remote computing terminal over the communication network. The second interface data may comprise a second widget indicating that an offer was not found.

In certain implementations, the present disclosure relates to a method for locating offers, comprising providing a first interface for operation at a remote computing terminal over a communication network. The first interface comprises a first widget configured to receive user information (e.g., personal user information). The method further comprises receiving, via the first interface, a first set of user information (e.g., personal user information), generating a first result via comparing the first set of user information (e.g., personal user information) to a list of users who have been pre-approved to receive an offer, and providing a second interface for operation at the remote computing terminal over the communication network. The second interface comprises a second widget including an indication of the first result.

In some embodiments, the method further comprises generating an API request based on the first set of user information (e.g., personal user information) and sending the API request to a remote data store, wherein the list of users is stored in the remote data store. The method may further comprise obtaining a set of criteria for identifying pre-approved candidates and generating a list of users who have been pre-approved for the offer based on the received set of criteria.

In certain implementations, the present disclosure relates to an apparatus for locating pre-approved offers of credit, the apparatus comprising a network interface and control circuitry configured to obtain, via the network interface, a first inquiry comprising a first set of user information (e.g., personal user information) and an indication of a first offer and transmit, via the network interface, a second inquiry comprising the first set of user information (e.g., personal user information), the indication of the first offer, and a request to access stored user records. The apparatus is further configured to obtain, via the network interface, an indication of a first result based on a comparison of the first set of user information (e.g., personal user information) to a list of users who have been pre-approved for the first offer and generate interface data comprising a widget including an indication of the first result.

In some embodiments, the control circuitry is further configured to generate an API request based on the received user information (e.g., personal user information) and transmit the API request to a remote data store, wherein the list of users is stored in the remote data store, and wherein the indication of the first result is obtained from the remote data store. The control circuitry may be further configured to obtain a set of criteria for identifying pre-approved candidates and generate a list of users who have been pre-approved for the offer based on the received set of criteria. The first set of user information (e.g., personal user information) may comprise one or more of a name and a social security number.

In some embodiments, the first result is indicative of a positive match and, in response to the indication of the positive match, the second widget comprises one or more fields for collecting a second set of personal information. The control circuitry may be further configured to receive, via the second widget, the second set of user information (e.g., personal user information). The second set of personal information may comprise one or more of a name, residential address, e-mail address, and social security number. In some embodiments, the control circuitry is further configured to generate a second result via comparing the second set of user information (e.g., personal user information) to stored user information and generate third interface data for operation at the remote computing terminal over the communication network, the third interface data comprising a third widget including an indication of the second result.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 illustrates a communication system for communication of various user information, software requests, credit offer status information, and other data in accordance with one or more embodiments.

FIG. 2 is a block diagram illustrating an example embodiment of the client server and/or affiliate server of FIG. 1 in accordance with one or more embodiments.

FIG. 3 is a flow diagram illustrating a process for determining offer eligibility through use of a data access request in accordance with one or more embodiments.

FIGS. 4A, 4B, 4C, and 4D are flow diagrams illustrating a process for determining offer eligibility through use of a widget in accordance with one or more embodiments.

FIGS. 5A, 5B, 5C, and 5D illustrate widget and web page diagrams corresponding to the various steps of the process of FIGS. 4A, 4B, 4C, and 4D in accordance with one or more embodiments.

FIG. 6 is a flow diagram illustrating a process for determining offer eligibility through use of a link to a landing page in accordance with one or more embodiments.

FIG. 7 is a flow diagram 700 illustrating a process for submitting and managing offer inquiries.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

The headings provided herein, if any, are for convenience only and do not necessarily affect the scope or meaning of the claimed invention. Disclosed herein are example configurations and embodiments relating to systems and methods for generating and/or locating consumer authentication and/or credit offer information.

### Overview

Certain financial lending systems implement pre-screening of selected consumers (e.g., individuals) for credit eligibility. Consumers who pass the pre-screen criteria may be pre-approved for credit offers. Pre-approved consumers are generally presented with a firm offer of credit, which may generally be delivered via physical direct mail and/or e-mail, and may include a unique approval code, or the like. In order to accept and fulfill the pre-approved offer electronically, a consumer may be required to possess and/or submit the provided approval code to the lender within the offer collateral or term. Consumers who have misplaced their approval code may generally have no simple method for accepting and fulfilling their pre-approved offer. Instead, such consumers may be required to contact the lender in some implementations, such as via telephone or lender website, and prove their identity before they are able to process their application. Moreover, consumers who have moved, changed e-mail address, postal address, or otherwise have not received, or are unaware of receiving, a credit offer sent by a lender may be completely unaware that they have been pre-approved. Moreover, in some embodiments, a relatively large amount of computational resources and/or communication resources can be used in pre-screening consumers for credit eligibility. For example, providing credit offers according to certain solutions can involve evaluating data across a large pool of users (e.g., an entire country's population) to determine a list of users who are pre-approved for an offer. This can require significant hardware resources, such as many server instances, processors, memory, etc. Further, this can require transmission and/or receipt of many communications to or from entities over various networks that can be distributed across many architectures or environments, in some instances, to establish an identity of a consumer, check the credit of the consumer, identify delinquent accounts associated with the consumer, determine a credit card utilization rate for the consumer, check a credit history of the consumer, determine income of the consumer, and so on. This can crowd the networks, ultimately causing communication delays in using the networks.

The terms “pre-approved” and “pre-approval” are used herein according to their broad and ordinary meanings, and may generally refer to pre-screening processes or offers initiated by, for example, a lending institution after an individual has been identified by a consumer credit agency/bureau on behalf of the lending institution as meeting certain qualifying criteria. Offers based on such pre-screening, which may be referred to as “pre-approved offers,” or the like, may then be sent to the identified individual(s). Where a recipient of a pre-approved offer accepts the pre-approved offer, a full application submission process may be initiated, wherein such recipients may likely be approved for credit when no substantial intervening changes in credit status have occurred in the time since the pre-approved offer was made.

The terms “pre-qualification” and “prequalified” are used herein according to their broad and ordinary meanings, and may generally refer to consumer/individual-initiated credit requesting processes or a status associated with an affirmative response to a consumer/individual-initiated credit request. For example, a consumer may initiate a pre-qualification process after receiving an invitation to initiate the pre-qualification process. Pre-qualification may generally not amount to a full application for credit, and therefore, only a “soft” pull of credit may be performed in connection therewith. In some situations, soft credit inquiries may be preferable over “hard” credit inquiries, as they may not generally result in a negative impact on the consumer's credit score. When a consumer passes the relevant pre-qualification requirements (e.g., according to the requirements of the potential lending institution), the consumer may then be invited to submit a full application for credit, approval of which may result in extension of credit to the consumer.

In some implementations, the present disclosure provides systems, devices, and/or methods for funneling or pushing consumers to either a pre-approval process interface or a pre-qualification process interface based on a determination of which process is desirable for the particular consumer. For example, in some embodiments, a lookup tool may be used to determine whether an active pre-approved offer exists, wherein if an existing active pre-approved offer is found, an associated pre-approval code may be pre-populated into a pre-approved form, while if an existing pre-approved offer is not found, then other personal information may be pre-populated into a pre-qualification form.

The terms “individual,” “consumer,” and “user” are used herein according to their broad and ordinary meaning, and may refer to a person or other entity that is potentially eligible for extension of credit from a lending institution. For example, an “individual,” “consumer,” or “user” may refer to an offeree or potential offeree of the described systems. An “individual,” “consumer,” or “user,” as described herein, may be an individual person, a group of persons, an entity (e.g., an organization or company), or a group of entities.

The systems and methods disclosed herein provide improvements over certain of the above-described computational systems. For example, embodiments of the present disclosure provide an efficient system for locating existing pre-approved offers and facilitating offer application processes. In some embodiments, a user may look-up or otherwise access offers by providing readily-available user information, such as the user's name and/or address. Offers may be stored and associated with user information (e.g., the user's name and/or address) and may be accessible via the Internet or other communication network. In this way, offers may be accessible to offerees substantially without requiring direct communication between an offeror and an offeree.

In some embodiments, techniques of the present disclosure enable an efficient use of computational and/or communication resources. For example, if processing has already been performed using various computational and/or communication resources to pre-approve a user, an offer can be provided to the user without having to perform the processing needed to approve the user again. This can conserve computational resources and/or communication resources (e.g., avoid redundant processing or communications that would otherwise be performed to approve the user a second time).

Further, in some embodiments, certain solutions of providing offers are implemented within different environments, with each environment implementing a different software or hardware architecture. For example, a first website can implement a first architecture to provide offers to consumers that visit the first website, a second website can implement a second architecture to provide offers to consumers that visit the second website, an email application can implement a third architecture to provide offers to consumers, and so on. In some embodiments discussed herein, a widget is implemented across a variety of environments to provide and/or obtain data regarding an offer in an efficient manner. For example, a single type of widget can be used across various web-based environments, email environments, applications, etc.

For illustrative purposes, certain embodiments are described herein with reference to financial systems involving credit offers made to users who have been pre-approved, wherein such pre-approval may be based at least in part on credit history, and/or other parameter(s). However, it should be understood that the various embodiments disclosed herein may be suitable for use in a variety of environments involving transmission of offers between an offeror and an offeree or a potential offeree. Based on the teachings herein, one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented, or a method may be practiced, using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different consumer goods and services industries. The detailed description and drawings are merely illustrative of the disclosure rather than limiting, the scope of the disclosure being defined by the appended claims and equivalents thereof.

The term “offer” is used herein according to its broad and ordinary meaning, and may refer to any communication or data communicated or extended by an offeror to an offeree for purposes of enabling an action on the part of the offeree. For example, a financial institution may extend a credit card offer to a user which allows the user to apply for and/or be approved for a credit card. The offer may be extended after the user is pre-approved to receive the offer.

Embodiments herein provide improved accessibility of credit offers to users through use of a variety of graphical user interfaces, such as certain web browser and/or mobile applications. In one embodiment, a user may transmit identifying personal information data to a remote server using, for example, a web browser or mobile application, and receive a response transmission from the remote server (e.g., using the web browser or mobile application) indicating whether the user has a pre-approved offer. In certain embodiments, the user may not be required to provide a unique approval code in order to access their pre-approved offer, and may instead simply be required to provide personal identifying information (e.g., the user's name, social security number, address, etc.). In this way, a user may be able to locate and respond to an offer even if the user has not received or has misplaced an approval code associated with the offer. Moreover, credit offers may be accessible remotely through use of communication systems described herein.

Embodiments disclosed herein further provide systems for effectively identifying users who have a pre-approved offer and/or users who can initiate the process of getting pre-qualified for an offer. In some embodiments, a user may interact with a computer system having access to stored user data. For example, a user may visit a website owned or operated by a lending institution. The user may have a registered account or other previous interactions with the lending institution, such that the institution has compiled user purchase history and/or credit score information, or other user credit information. Using stored user credit information, the lending institution can interact with a credit database server to determine whether the user satisfies pre-approval criteria for a credit offer. If the lending institution determines that the user satisfies the relevant pre-approval criteria, the lending institution may send a pre-approved offer to the user. When the user accesses a website associated with the lending institution and/or a different website, a web page, link, and/or widget may be generated and/or displayed to the user in an interface inviting the user to determine whether the user has a pre-approved offer by providing identifying personal information. The identifying personal information may be used by the computer system described herein to determine that the user has a pre-approved offer.

Moreover, embodiments disclosed herein provide a cost-effective system for providing offers to large groups of users by limiting reliance on direct mail. For example, providing credit offers according to certain solutions can involve evaluating credit reports across a large pool of users (e.g., an entire country's population) to determine a preliminary list of users who are pre-approved for an offer. To limit the cost of direct mail, the preliminary list of users may be further filtered by evaluating how likely users are to respond to an offer. Users who are evaluated to be more likely to respond can be included in a final list of users. Some embodiments described herein allow offerors to provide offers to visitors of websites, mobile applications, web applications, kiosks, and other software and hardware systems. As such, direct mail utilization and reliance upon direct mail may be eliminated or reduced. Moreover, offerors may advantageously be able to provide offers to larger sets of users in a cost-effective manner where direct mail is not required for the entire set of users.

It should be understood that certain ordinal terms (e.g., “first” or “second”) may be provided for ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to any other element, but rather may generally distinguish the element from another element having a similar or identical name (but for use of the ordinal term). In addition, as used herein, indefinite articles (“a” and “an”) may indicate “one or more” rather than “one.” Further, an operation performed “based on” a condition or event may also be performed based on one or more other conditions or events not explicitly recited.

Communication System

FIG. 1 illustrates an example communication system 100 for transmission of various user information, requests, credit offer status information, and other data. Components of FIG. 1 may interact through use of a network 115. The network 115 may be any of a variety of types of wired and wireless networks. In some embodiments, the network 115 may employ widely used networking protocols, such as a wireless 802.11 protocol. While a single network 115 is illustrated, the network 115 may represent multiple networks or a system of networks which may comprise a variety of network types. In certain embodiments, the network 115 comprises the Internet. It should be understood that any reference herein to “user information” should be understood to refer to any type of user information, including personal user information.

The network 115 may facilitate communication between a variety of components of the system 100, including a user terminal 110, a client server 105, an affiliate server 120, a credit records database 125, and a consumer credit server 130. The user terminal 110 may be one or more of any type of computing device (e.g., smartphones, laptops, desktop computers, tablets, kiosks, wearable computing devices, or the like) suitable for receiving and transmitting data over the network 115. Communication in the system 100 may be bi-directional with respect to at least some of the illustrated communication links. For example, user information may be transmitted from the user terminal 110 to the client server 105 and/or affiliate server 120 via the network 115. The client server 105 and/or affiliate server 120 may submit data access requests to the credit records database 125 and/or consumer credit server 130 via the network 115. The credit records database 125 and/or the consumer credit server 130 may return requested data to the client server 105 and/or affiliate server 120 via the network. The client server 105 and/or affiliate server 120 may process the returned data and transmit certain data to the user terminal 110.

In some embodiments, one or more of the components illustrated in FIG. 1 may be combined into a single component. For example, the client server 105 and affiliate server 120 may be combined into a single server. In another example, the credit records database 125 and consumer credit server 130 may be separate devices or combined in a single device. In some embodiments, the client server 105, affiliate server 120, or the consumer credit server 130 may be in exclusive communication with the credit records database 125. In some embodiments, one or more of the components may be excluded from the system 100. The communication system 100 may be used to implement systems and methods described herein. Each of the user terminal 110, client server 105, affiliate server 120, credit records database 125, and/or consumer credit server 130 may be located remotely from one or more other components of the system 100 and may transmit data to one or more components of the system 100 remotely over the network 115.

In an embodiment, a user may use the user terminal 110 to access a website, web page, web application, mobile application, or any other electronic content accessible over the network 115. The electronic content accessed by the user may be provided by the client server 110 or affiliate server 105. In one example, a user 101 may access a website distributed by the affiliate server 120. In some embodiments, a user may register an account with content provided by the client server 105 or affiliate server 120. For example, a user may use the user terminal 110 to sign up for an account with a website provided by the affiliate server 120. Registering for an account may involve a user accessing the user terminal 110 to send user information to the client server 105 or affiliate server 120. For example, the user may input contact information (e.g., an e-mail address, physical address, phone number), password, payment information (e.g., credit or debit card information), or any other information to the user terminal 110 during a registration process. The user information may be sent by the user terminal 110 to the client server 105 and/or affiliate server 120 via the network. The user may also provide a variety of other information to the client server 105 and/or the affiliate server 120 via the user terminal 110 and network 115, including purchasing history, bank account information, purchasing interests, and/or other information.

The client server 105 and/or affiliate server 120 may gather a variety of user information through use of a user-registered account or otherwise. For example, user purchases and other activity may be sent to the client server 105 and/or affiliate server 120. User activity may be recorded and processed at the client server 105 and/or affiliate server 120.

In some embodiments, the client server 105 and/or affiliate server 120 may store various data and/or may send various data to associated external databases for storage. For example, user information received and/or processed at the client server 105 and/or affiliate server 120 may be stored as user records. User records may be associated with a particular user.

In some embodiments, the credit records database 125 may store credit offer criteria, lists of users with pre-approved credit offers, and/or other credit records. The stored credit records may be received at the credit records database 125 and/or credit server 130 from the client server 105, affiliate server 120, and/or other external sources. The client server 105 and/or affiliate server 120 may access credit records stored in the credit records database 125 by submitting requests to the credit records database 125 and/or consumer credit server 130, or to a different server with access to the credit records database 125. Data access requests may identify one or more individual users. For example, the client server 105 and/or affiliate server 120 may send, via the network 115, an Application Programming Interface (API) request to the credit records database 125 and/or consumer credit server 130, or to a different server with access to the credit records database 125. The credit records database 125 and/or consumer credit server 130 may receive requests, access stored data identified in or associated with the requests, and send the accessed data, via the network 115, to the client server 105, the affiliate server 120, and/or a different server with access to the credit records database 125.

In one example embodiment, a user may access a user terminal 110 to visit a personal finance website. In one example use case, the user 101 may visit a website directed to assisting users in preparing tax forms and/or accessing credit scores. The website may be provided by the affiliate server 120. The user 101 may access the user terminal 110 to open an Internet browser and identify the desired website. The user terminal 110 may submit a request, via the network 115, to the affiliate server 120 to access the desired website. The affiliate server 120 may, via the network 115, receive the request, access the identified website, and return the requested website data to the user terminal 110. The user terminal 110 may receive the website data and open the website in the Internet browser. The user 101 may have a registered account with the website. Accordingly, if the user signs into the website, the affiliate server 120 may be able to access stored information about the user. The information may be stored at the affiliate server 120 or in an external database. The stored user information may be information previously provided to the website by the user, for example the user's name, contact information, and other personal information (e.g., social security number, bank account information). In one example, the user 101 may provide personal information to the website for the purpose of being considered for pre-qualification to be approved for a credit card.

The affiliate server 120 may use stored user data and/or user information received from the user terminal 110 to request a search at the credit records database 125. The affiliate server 120 may prepare a request that includes user information (e.g., the user's name and social security number) and send the request to the credit records database 125 and/or consumer credit server 130. The request may be a request to determine whether the user satisfies credit offer criteria or whether there is a pre-approved credit offer for the user. In some embodiments, a user 101 may use the user terminal 110 to request searches of the credit records database 125. The user request from the user terminal 110 may be received at the client server 105 or affiliate server 120. The client server 105 or affiliate server 120 may then send a request to the credit records database 125 and/or consumer credit server 130 in response to receiving the user request.

A user request may be in response to a prompt provided to the user terminal 110 by the client server 105 or affiliate server 120. The client server 105 or affiliate server 120 may send graphical interface data representing a first graphical interface to the user terminal 110 to prompt the user to provide information to determine whether the user has a pre-approved credit offer or whether the user can pre-qualify for a credit offer. The terms “graphical interface data” and “interface data” are used herein according to their broad and ordinary meaning, and include data and/or code providing instructions for generation and/or display of various graphical icons and other visual identifiers and/or features in a display device. That is, graphical interface data may represent various graphical icons and/or other visual identifiers or features. Furthermore, graphical interface data may refer to any type of user interface pages or portions of pages having any type of content. For example, graphical interface data may refer to a page of a website, a page of a network-enabled application, or the like, or to any type of code used by a user interface to generate some or all of a webpage, content page, or interface. Graphical interface data may comprise code conforming to any suitable or desirable language, such as hypertext markup language (HTML) code, Java or Javascript code, Android code, iOS code, other embedded device operating system code, or the like. The terms “graphical interface,” “interface,” and “web page” may be used to refer to a graphical interface represented by graphical interface data. In some contexts herein, the terms “interface” and “graphical interface” may refer to graphical interface data.

In one example, a user may input using the user terminal 110 various personal information, which may include one or more of the user's name, address, and social security number. The user terminal 110 may send the personal information to the client server 105 and/or affiliate server 120. Based on the received personal information, the client server 105 and/or affiliate server 120 may send a request to determine whether the user has an existing pre-approved offer of credit and/or may be likely to pre-qualify for a certain credit offer (e.g., an offer to obtain a credit card). Based on the determination, the client server 105 and/or affiliate server 120 may generate and/or provide graphical interface data representing a second interface and/or may route the user terminal 110 to a second interface. The second interface may indicate that the user has a pre-approved offer, that the user does not have a pre-approved offer, and/or that the user can provide additional personal information to confirm the user's identity and/or to apply for a pre-qualified offer.

In response to the second interface, the user may provide additional personal information to the user terminal 110. For example, the second interface may request the user's name and/or social security number. After the user inputs the additional personal information, the user terminal 110 may send the additional personal information to the client server 105 and/or affiliate server 120.

In some embodiments, the user terminal 110 may communicate bi-directionally with the client server 105 and/or the affiliate server 120. For example, the user may use the user terminal 110 to access a website hosted by the affiliate server 120. Accordingly, the user terminal 110 may send information to the affiliate server 120, receive prompts and/or other data from the affiliate server 120, and provide additional information to the affiliate server 120. Based on information received from the user terminal 110, the affiliate server 120 may send a request (e.g., an API request) to the credit records database 125 and/or consumer credit server 130 to search credit records. For example, the credit records database 125 may be searchable to determine whether users have existing pre-approved offers (e.g., offers to receive a credit card). The affiliate server 120 may send a request that includes user information, which may comprise additional information provided by the user terminal 110 in response to a prompt from the affiliate server 120. The credit records database 125 and/or consumer credit server 130 may use the information received from the affiliate server 120 to access stored data associated with the received information. For example, the received information may include a user's name and/or social security number or a portion of the user's social security number. The credit records database 125 and/or consumer credit server 130 may execute a database query to determine if there is a match between the received information and a set of data stored in the credit records database 125. If there is a match in the credit records database 125, the credit records database 125 and/or consumer credit server 130 may return a confirmation to the affiliate server 120. If the credit records database 125 and/or consumer credit server 130 determines that the received information matches multiple records in the credit records database 125, the credit records database 125 and/or consumer credit server 130 may return to the affiliate server 120 an indication that multiple matches exist.

In another example, a user 101 may use a user terminal 110 to access a website hosted by the client server 105. In this example, the client server 105 may communicate bi-directionally with the user terminal 110, credit records database 125, and/or consumer credit server 130 to send requests and receive various data.

In some embodiments, a user may use a user terminal 110 to access a website, web page, web application, or mobile application that is hosted at least in part by both the client server 105 and the affiliate server 120. For example, a user may use a user terminal 110 to access a website hosted by the affiliate server 120. The user terminal 110 may further access a web page within the website that includes a widget hosted by the client server 105. The term “widget” is used herein according to its broad and ordinary meaning. Furthermore, as used herein, “widget” may be used to refer to any interface or component of an interface that is configured to receive and/or display various information. A widget, as used herein, may be a web page, mobile application page, or a component or portion of a web page or mobile application page.

A widget may be integrated into another web page. Integrating a widget may involve specifying (e.g., at the client server 105 and/or affiliate server 120) the dimensions of the widget, for example a width (e.g., in number of pixels) and height (e.g., in number of pixels). The dimensions of the widget may be adjusted to accommodate browser defaults if any. Dimensions may be specified, for example, in an Inline Frame (iFrame) element. A widget integrated into another web page may be positioned anywhere in the web page interface.

In certain embodiments, a widget generated by the client server 105 may be integrated in an interface (e.g., a web page) hosted by the affiliate server 120 or vice versa. A widget may collect tracking information (e.g., a tracking identifier) identify a host server of the interface integrating the widget to allow for data tracking and analytics. For example, if a website generated by the affiliate server 120 integrates a widget generated by the client server 105, the widget may include an identifier which identifies the affiliate server 120. Accordingly, usage of the widget (including data collected by the widget) may be stored and associated with the host servers integrating the widget. The client server 105 (or affiliate server 120) may store widget usage data of external servers hosting its widgets as well as a master list of identifiers collected by the widgets.

In some embodiments, a widget may be included in a web page based on a determination at the client server 105 that the user accessing the web page may be interested in applying for an offer. The widget may have interactive features. For example, the widget may present a message to the user that indicates the user may have a pre-approved credit offer and may prompt the user to provide personal information to confirm the offer. The user may use the user terminal 110 to input information into text boxes in the widget. The user terminal 110 may send the information inputted into the widget to the client server 105. The client server 105 may use the received information to send a request to the credit records database 125 and/or consumer credit server 130 and the credit records database 125 and/or consumer credit server 130 may determine if there is a match.

Based on information received from the credit records database 125 and/or consumer credit server 130, the client server 105 and/or affiliate server 120 may generate additional data to send to the user terminal 110. In some embodiments, based on receiving a match confirmation from the credit records database 125, the client server 105 and/or affiliate server 120 may provide confirmation information to the user terminal 110. For example, if a user uses a user terminal 110 to access a website hosted by the affiliate server 120, the affiliate server may route the user terminal 110 to a web page that indicates a match for the user. In another example, if the accessed website is hosted by the affiliate server 120 and includes a widget hosted by the client server 105, the client server 105 may provide a message to be presented within a widget that indicates a match to an existing active offer for the user. The widget may be presented on a web page accessed by the user terminal 110.

In some embodiments, the client server 105 and/or affiliate server 120 may request additional information from the user terminal 110. For example, based on a determination that there is a match between user information and data in the credit records database 125, the client server 105 and/or affiliate server 120 may route the user terminal 110 to a web page requesting further information from the user (e.g., the user's address). In another example, based on a determination that there is a match between user information and data in the credit records database 125, the client server 105 and/or affiliate server 120 may provide a widget to the user terminal 110 that requests further information from the user to confirm an offer.

In some embodiments, based on a determination that there are multiple matches between user information and sets of data in the credit records database 125, the client server 105 and/or affiliate server may request further information from the user terminal 110. For example, the credit records database 125 and/or consumer credit server 130 may locate multiple users having identical information (e.g., same first and last name). In such a case, the client server 105 and/or affiliate server 120 may route the user terminal 110 to a web page or provide a widget to user terminal 110 indicating that more information from the user is needed. The client server 105 and/or affiliate server 120 may each be split into two or more separate servers or systems or may be combined into a single server or system.

### Computer System

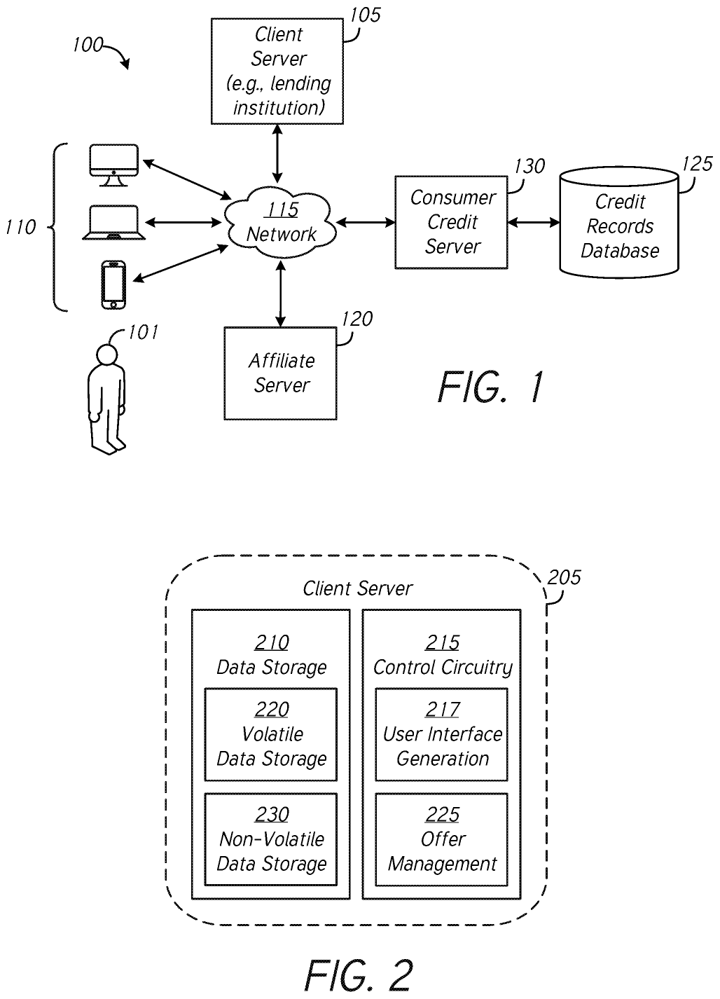

FIG. 2 is a block diagram illustrating components of an example embodiment of the client server 105 and/or affiliate server 120 of FIG. 1. The hardware and/or software components in FIG. 2 may be included in any of the devices of the communication system 100 (e.g., the user terminal 110, credit records database 125). These components may be used to implement systems and methods described herein.

The client server 205 includes certain control circuitry 215, which may comprise any number of hardware and/or software or firmware components. For example, the control circuitry 215 may include one or more application specific integrated circuits (ASICs), field-programmable gate arrays (FPGAs), circuits, digital logic circuits, analog circuits, a combination of discrete circuits, gates, or any other type of hardware or combination thereof. In addition, or alternatively, the control circuitry 215 may comprise one or more processors or processor circuitry, and/or instructions executable with by one or more processors or processor circuitry to implement one or more of the features of the control circuitry 215. The control circuitry 215 can take the form of processing circuitry, one or more microprocessors or processors, and/or a computer-readable media that stores computer-readable program code (e.g., software or firmware) executable by the processing circuitry, and/or one or more logic gates, switches, application specific integrated circuits (ASICs), programmable logic controllers, or embedded microcontrollers.

The control circuitry 215 comprises at least user interface generation circuitry 217 and offer management circuitry 225. Although the diagram of FIG. 2 illustrates the user interface generation circuitry 217 and the offer management circuitry 225 as separate functional components, it should be understood that such components may be part of a single computing device, or may be combined in some way in some embodiments, or the functions thereof may be divided into additional functional and/or hardware units not shown in FIG. 2. Furthermore, although the user interface generation circuitry 217 and the offer management circuitry 225 are illustrated as part of the control circuitry 215, it should be understood that such functional units/circuitry may be distributed in any manner, and one or more components of the control circuitry 215 may be part of a separate and/or remote system with respect to one or more other components of the control circuitry 215. As used herein, one or any combination of the control circuitry 215, the user interface generation circuitry 217 and the offer management circuitry 225, and/or the data storage 210, including the volatile data storage 220 and the non-volatile data storage 230 can be referred to as “control circuitry.”

In some embodiments, the various functional units described herein may be implemented by either hardware or software. Various software modules included in the system 205 may be stored in the data storage 210, such as in the non-volatile data storage 230, or on computer readable storage device(s) separate from the communication system 100 and in communication with the communication system 100 via the network 115 or other appropriate means.

The system 205 may comprise, for example, a server or workstation or a computer that is compatible with any of a variety of operating systems, including IBM, Macintosh, or Linux/Unix. In an embodiment, the control circuitry 215 of the system 205 further includes one or more processors and/or connectivity features, such as data transmission busses, configured to facilitate transmission of data between components of the system 205.

The control circuitry 215 may control operation of the system 205. The control circuitry 215 may comprise or be a component of a processing system implemented with one or more processors. The control circuitry 215 may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

The system 205 may include user interface generation circuitry 217. In some embodiments, the user interface generation circuitry 217 may comprise code stored in the data storage device 230 as executable software code that is executed by the control circuitry 215. The system 205 may be configured to use the user interface generation circuitry 217 to perform various methods and/or processes as described herein.

The user interface generation circuitry 217 may be configured to generate and/or operate user interface data representing user interfaces of various types. In some embodiments, the user interface generation circuitry 217 may be configured to generate graphical user interface data representing graphical interfaces for display in a web browser or computer/mobile application. In some embodiments, the user interface generation circuitry 217 may provide an application or similar module for download and operation on the user terminal 110 (FIG. 1), through which the user and system 205 may interact. The graphical interfaces may, in some embodiments, be specific to a type of device, such as a mobile device or a desktop web browser, to maximize usability for the particular device. In some embodiments, the user interface generation circuitry 217 may also interact with a client-side application, such as a mobile phone application, a standalone desktop application, or user communication accounts (e.g., e-mail, SMS messaging, etc.) and provide data as necessary to display offer information.

The user interface generation circuitry 217 may receive data input from a variety of devices, including a keypad, microphone, touchpad, speaker, display, and/or any other commonly available input/output devices and interfaces. The user interface generation circuitry 217 may provide output data that may be used for interface display on a variety of display devices, such as a monitor, that allows the visual presentation of data to the consumer.

In some embodiments, the user interface generation circuitry 217 may interface with various external devices. For example, the system 205 may be electronically coupled to the network 115 (FIG. 1). Accordingly, the user interface generation circuitry 217 may provide an interface allowing for communication with the network 115, for example, via a wired communication port, a wireless communication port, or combination thereof. The network 115 may allow various computing devices and/or other electronic devices to communicate with each other via wired or wireless communication links.

The data storage 210, which may comprise both non-volatile data storage 230 and volatile data storage 220 (e.g., RAM), may store and provide instructions and data to the control circuitry 215. For example, inputs received by one or more components of the system 205 may be stored in the volatile data storage 220. Inputs received may include user information received from the user terminal 110 (FIG. 1) and data records received from the credit records database 125 and/or consumer credit server 130 (FIG. 1). The control circuitry 215 may perform logical and arithmetic operations based on program instructions stored within the data storage 210. Code/Instructions stored in the data storage 210 may be executable to implement the methods described herein. For example, the non-volatile data storage 230 may store software or information (for example, user personal information and offer data). “Software” shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the control circuitry 215 to perform the various functions described herein. Accordingly, the system 205 may include, e.g., hardware, firmware, and software, or any combination therein. The non-volatile data storage 230 may comprise one or more hard drives, diskettes, solid state drives, or optical media storage devices.

The offer management circuitry 225 may comprise code stored in the data storage 230 as executable software code that is executed by the control circuitry 215. The offer management circuitry 225, and other modules and devices in the system 205, may include components, such as hardware and/or software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 2, the offer management circuitry 225 may be configured to perform the various methods and/or processes as described herein.

The offer management circuitry 225 may be configured to generate data access requests for determining offer eligibility and likelihood of offer eligibility for users. The offer management circuitry 225 may access user information received from the user terminal 110 (FIG. 1). The user information may be stored, for example, in the data storage 230 or an external server or database. User information may include a user's name, social security number, address, phone number, etc. offer management circuitry 225. In some embodiments, the offer management circuitry 225 may receive user offer information from the memory 220, data storage device 230, or an external database.

The offer management circuitry 225 may use user personal information (e.g., user credit score) to generate and/or send data access requests (e.g., API requests) to determine whether users have pre-approved credit offers. For example, the offer management circuitry 225 may determine if a user's personal information is matched to a pre-approved offer. Based on determining that the user has a pre-approved offer, the offer management circuitry 225 may send instructions to the user interface generation circuitry 217 (or other component) to notify the user that the user may be eligible for the offer. The user interface generation circuitry 217 may send offer data to the user terminal 110. For example, the offer data may comprise a web page or mobile application page indicating to the user that the user may be eligible for an offer and prompting the user to provide various information to confirm the offer. The offer data may be included in a widget displayed on the user terminal 110. The offer data may alternatively comprise a link which the user may select to be directed to an offer web page or mobile application page. Such a link may be presented in a web page or mobile application page on the user terminal 110.

In certain embodiments, the offer management circuitry 225 may determine whether a user has an active pre-approved offer based on data records received from the credit records database 125 (FIG. 1). The offer management circuitry 225 may send instructions to the user interface generation circuitry 217 to notify the user that the user has a pre-approved offer, that an offer was not located for the user, that an offer could not be verified for the user, or that more information is needed. The user interface generation circuitry 217 may send interface data to the user terminal 110 indicating an appropriate message to the user. The interface data may comprise a web page, mobile application page, widget, or other user interface item.

### Offer Location Via Data Access Request

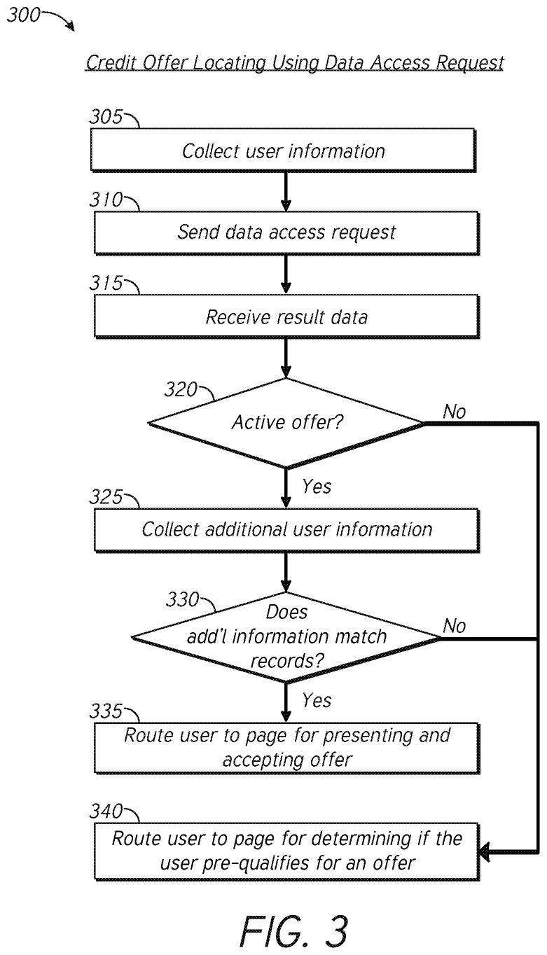

FIG. 3 is a flow diagram illustrating a process 300 for authenticating an end user's identify and determining if an offer is available for that specific end user through use of a data access request in accordance with one or more embodiments of the present disclosure. The term “data access request” is used herein according to its broad and ordinary meaning and may refer to a set of data instructions, routines, and/or protocols for managing communication between computing components. A data access request may be configured to validate user information according to specified categories, which may include a user's first name, last name, social security number, street address, city, state, and zip code. The user information may be used to narrow a search to focus on appropriate data.

In some embodiments, a data access request may include one or more header parameters, for example an identifier of the entity submitting the data access request (e.g. client or affiliate) and an identifier of a media type (e.g., content type) used in the data access request body (e.g., JSON). A data access request may further include various body parameters, for example a user's first name, last name, street address, zip code, city, state, and social security number.

A data access request sent to a computer system may generate a success response, a fraud response, or an error response from the computer system. In one example, a success response may cause a redirect to a particular web page (e.g., a website hosted by the client server) and may provide a message along with an indication of whether a match was found, and if so, how many matches. A fraud response may provide a message indicating that no matches were found. An error response may provide a message indicating a specific error (e.g., a missing parameter or an unrecognized source computer).

In some implementations, the process 300 is implemented in whole or in part by control circuitry of a computing system or server, such as the client server system 105 of FIG. 1. The below description of process 300 describes an example method involving personal finance. However, the process 300 is not limited to the field of personal finance and is generally directed to any method of determining offer eligibility.

At block 305, the process 300 involves collecting user information. In some embodiments, the user information may be collected at a user terminal and sent by the user terminal to a first server. The user terminal may be any device configured to receive input from a user and transmit data (e.g., via a wired or wireless network) to the first server. Suitable user terminals have been described herein and may include, for example, smartphones, laptops, desktop computers, tablets, kiosks, and others. A user may provide the user information through use of a user interface displayed on the user terminal.

For example, a user, via a user terminal, may use a web browser to visit a website hosted by the first server. The website and/or the first server may be owned and/or operated by a personal finance company that facilitates access of credit scores for users. Accordingly, the user may provide personal information to the website that is necessary for accessing a credit score (e.g., the user's name, social security number, address, etc.). The user may have a registered account or otherwise have previous dealings with the company and/or the website. The first server may have access to stored user information either provided by the user or otherwise collected by the first server. The first server may store or may have access to an external data store that stores user information. The first server may receive user information collected at the website.

At block 310, the process 300 involves sending a data access request to a user records database. For example, the first server may send the data access request to the user records database. The data access request may be an API request or other software query suitable for requesting access to a data store. The data access request may include the received user information. The data access request may also include information identifying a specific offer.

In one example, the first server may send an API request to a data store (e.g., a server or database) owned or operated by a consumer credit reporting agency. The data store may store user credit report information. The data store may also have stored eligibility criteria for various offers. For example, the data access request may include information identifying a credit card offer from a specific credit card company. The credit card company may have certain criteria for issuing credit card offers to users. For example, the credit card company may have an established credit score threshold that must be met for a user to receive a credit card offer. The data store, or a server with access to the data store, may store the threshold information for the credit card company. Accordingly, in response to receiving the data access request, the data store may determine if the user identified in the API request has an offer.

In some embodiments, a data store may store a list of users pre-approved for certain offers. In response to receiving an API request from the first server, a data store may determine whether there is a match between a user name identified in the API request and a list of pre-approved users in the data store.

At block 315, the process 300 involves receiving result data from the user records database. The result data may comprise user records, for example stored personal information of users identified in the data access request. In some embodiment, the result data may comprise an indication (e.g., “yes” or “no”) of whether users identified in the data access request matched stored user records, how many matches were found, and whether any of the matches are directed to active offers.

At decision block 320, the process 300 involves determining whether the result data indicates at least one active offer associated with the user information. In certain embodiments, there may be inactive offers associated with user information. For example, if an offer extended to a user has expired, the offer may be inactive. In this example, the result data may indicate that the user is associated with an offer but that the offer is inactive. If there is an active offer associated with the user information, the process 300 continues to step 325. If there is not an active offer associated with the user information, the process 300 continues to step 340.

At block 325, the process 300 involves collecting additional user information. The additional user information may be a social security number, address, e-mail address, name, occupation, gender, age, or any other information which may be used to identify a user. In some embodiments, the additional user information may be collected at a web page and/or widget. For example, a user terminal may be routed automatically to a web page for collecting the additional information or a hyperlink may be provided to the user terminal and the user may select the hyperlink to be routed to the web page. In certain embodiments, a web page for collecting additional user information may include a message to the user indicating that the additional information is needed to verify the user's identity.

In some embodiments, the additional information provided by the user may be sent, by the user terminal, to the first server and/or a second server. The first server and/or second server may send an additional data access request to the data store to determine if the additional information matches stored data records.

At decision block 330, the process 300 involves determining whether the additional information provided by the user matches at least one active offer based on the stored data records. The first server and/or second server may send an additional data access request (e.g., an API request) including the additional information to a server and/or database (e.g., credit records database 125 and/or consumer credit server 130, FIG. 1). It may be determined if the additional information included in the inquiry matches stored data records. If the additional information matches at least one active offer based on the stored data records, the process 300 continues to block 335. If the additional information does not match at least one active offer based on the stored data records, the process 300 continues to block 340.

At block 335, the process 300 involves routing the user terminal to a first web page for presenting the offer and a link to accept the pre-approved offer. The first web page may provide offer details and/or a reservation approval code and a hyperlink to an offer acceptance data entry page which the user may fill out to accept the offer. If the user selects the hyperlink and is routed to the offer acceptance data entry page, the offer acceptance data entry page may be at least partially pre-filled with user information collected at block 305 and/or block 325. The first web page may be part of a website accessed by the user or a different website.

At block 340, the process 300 involves routing the user to a second web page. The second web page may indicate that the user does not have a pre-approved offer and/or may prompt the user to input information to determine if the user is eligible for pre-qualification. The second web page may include a hyperlink that, when selected by the user, causes the user terminal to be routed to a pre-qualification data entry page. The pre-qualification data entry page may be at least partially pre-filled with user information collected at block 305 and/or block 325.

### Offer Location via Widget

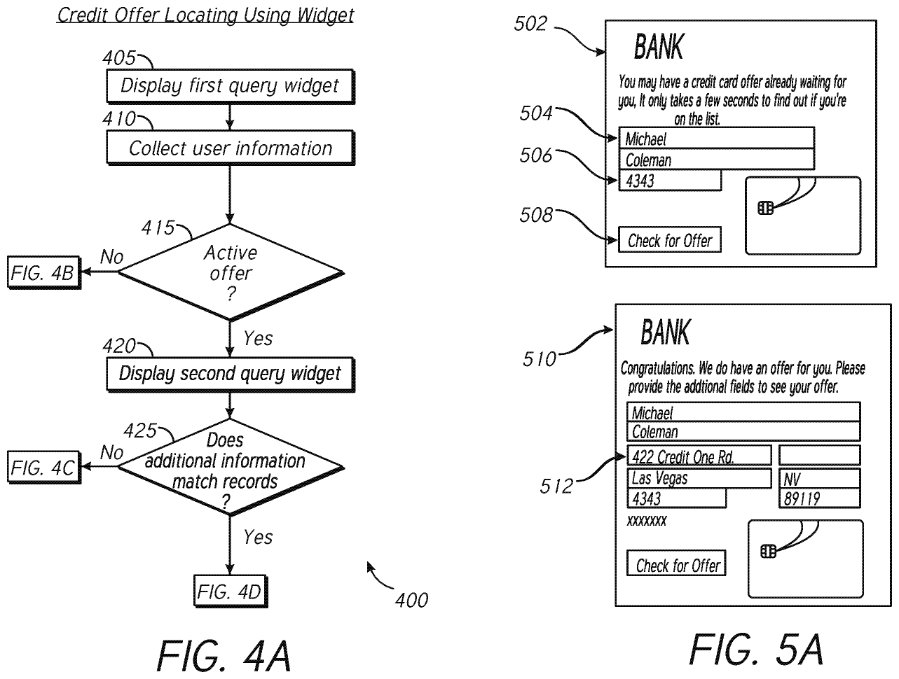

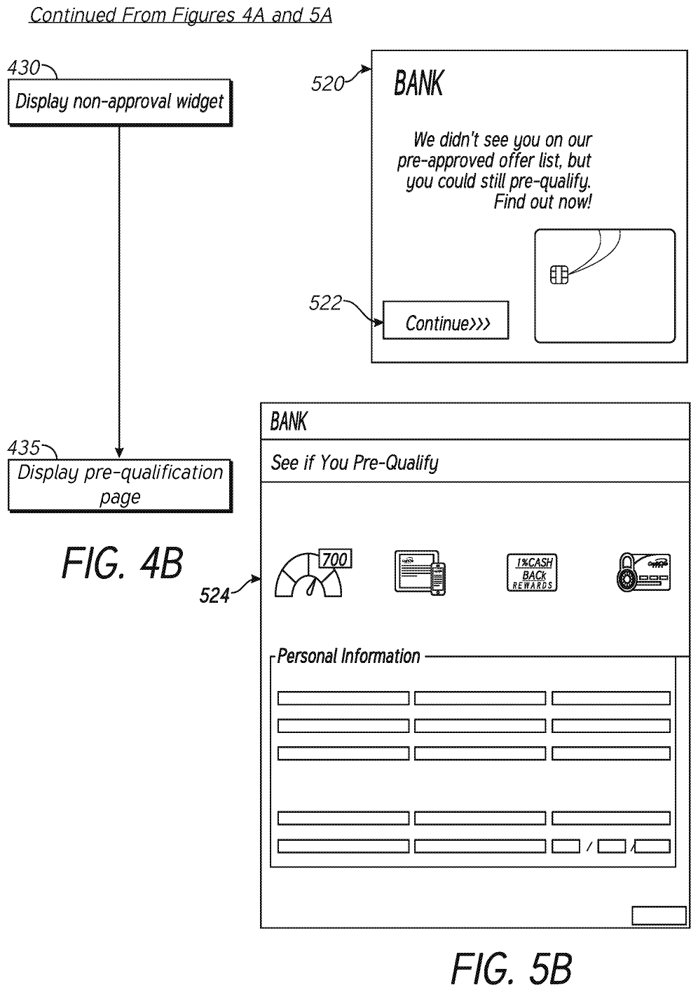

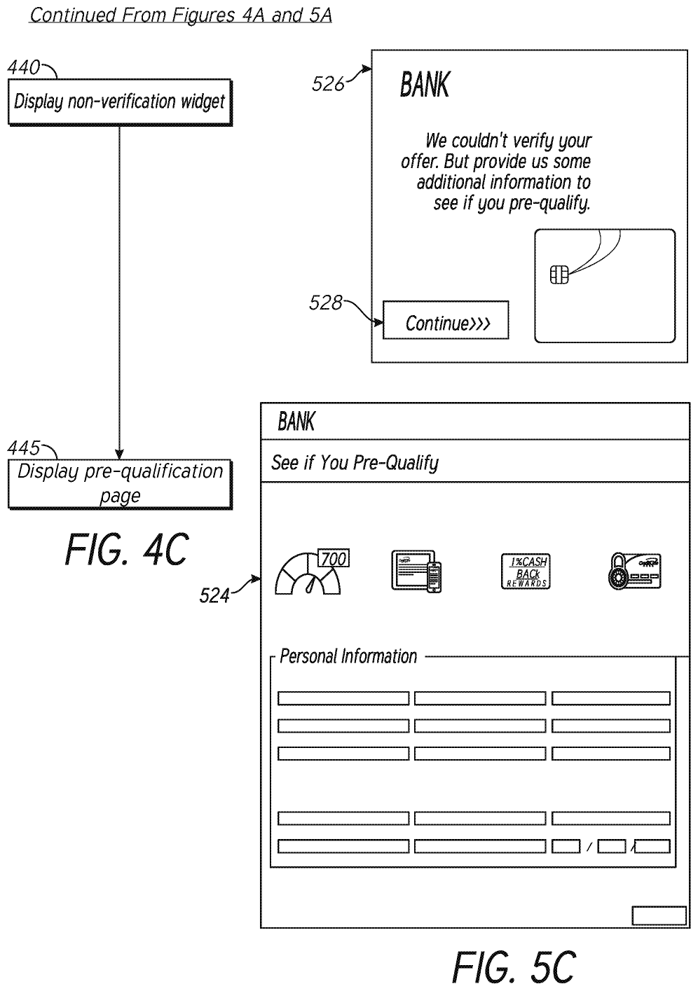

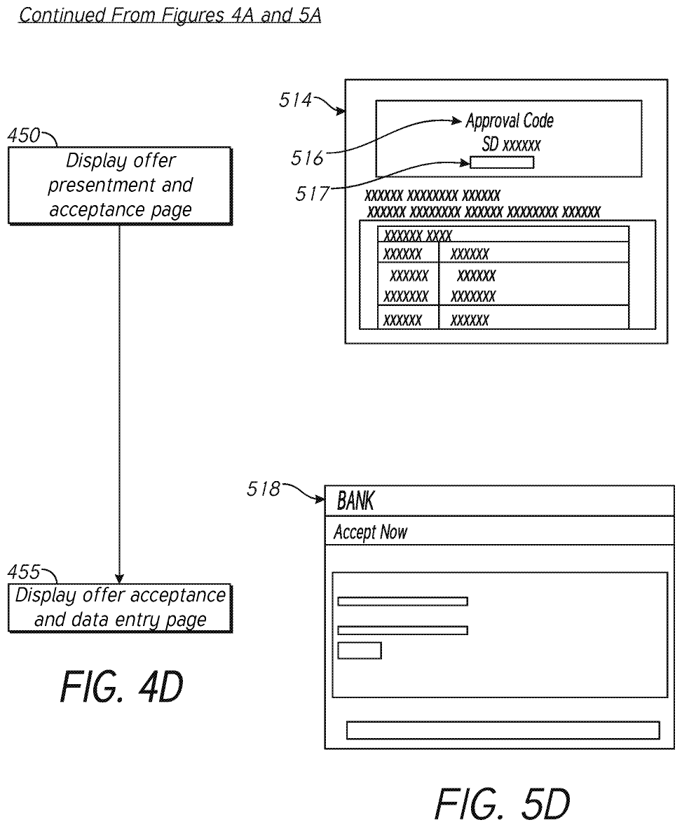

FIGS. 4A, 4B, 4C, and 4D are flow diagrams illustrating a process 400 for determining offer eligibility through use of a widget, web page, or mobile application in accordance with one or more embodiments of the present disclosure. FIGS. 5A, 5B, 5C, and 5D illustrate widget and/or web page diagrams corresponding to the various steps of the process 400 to further illustrate features of the described embodiments. Each of the widget diagrams illustrated in FIGS. 5A, 5B, 5C, and 5D may represent separate widgets or different pages and/or messages of a single widget. Furthermore, each of the illustrated widget diagrams may be represented by graphical user interface data generated by a computer device, system, and/or server in response to the various illustrated events and/or process steps. For example, the various widgets and/or interfaces shown and described may be generated using graphical interface data generated, provided, and/or presented by a client server system (e.g., the client server system 105 of FIG. 1 and/or client server system 205 of FIG. 2), and/or other computing system in accordance with embodiments of the present disclosure. In some implementations, the process 400 is implemented in whole or in part by a controller of a data storage device, which may advantageously allow for the controller to be designed for a particular product or system. In some implementations, the process 400 may be implemented without requiring utilization of logic in the associated nonvolatile memory module, such that the functional steps of the process 400 are implemented outside of the nonvolatile memory module, such as in the controller of the data storage device. In some embodiments, the process 400 may be implemented in connection with, or in response to, system boot up of the data storage device or system, or associated computing device or system. For illustrative purposes, steps of the process 400 and/or diagrams may be described with reference to widgets. However, the described process 400 and diagrams may be implemented using web pages, mobile applications, e-mail, and/or other electronic documents and/or interfaces.

At block 405, the process 400 involves displaying a first query widget 502 to a user interface. The first query widget 502 may be included in a web page accessed by a user using a user terminal. The user interface may be generated and provided to the user terminal by a first server and the first query widget 502 may be generated and provided to the user terminal by the first server or a second server. The first query widget 502 may invite the user to provide various user information, which may include the user's name 504 and at least a portion of the user's social security number 506, or utilize other user-identifying personal information queries. The user may select an icon 508 to submit the user information as a data request or inquiry. The first query widget 502 may identify a particular organization or offer. The first query widget 502 may further indicate that by submitting an inquiry, the user can determine if the user is eligible for an offer.

At block 410, the process 400 involves collecting user information. The user information may be received at a user terminal and transmitted from the user terminal to the first server or a second server. For example, the first server may be a hosting server of a web page accessed by the user terminal and the second server may be a hosting server of the first query widget 502. In some embodiments, the first server may host the web page and the first query widget 502. The first server and/or second server may generate an inquiry including at least a portion of the received user information and identifying an offer. The first server and/or second server may send the inquiry to a database storing user identifying information (e.g., name, social security number, etc.). The database may be searchable and may be configured to match received data to stored records. The database may receive the inquiry from the first server and/or second server and determine whether there is a match between the stored data and the user information in the received inquiry. The database may return a set of result data that may include among other things, an indication of whether there was a match (e.g., “yes” or “no”) between the stored data and the user information in the received inquiry, a number of matches, and an indication of whether there is an active offer for a matched user.

At decision block 415, the process 400 involves determining whether the stored data indicates that at least one active offer is associated with the user information. In an embodiment, the first server and/or second server may determine whether there is at least one active offer based on data received from the database. If there is at least one active offer, the process 400 continues to block 420. If there is not at least one active offer, the process 400 continues to block 430 in FIG. 4B.

At block 420, the process 400 involves displaying a second query widget 510 on the user interface. Although the process 400 is described and shown in the context of displaying or presenting a second widget 510, in some implementations, the information displayed in the second widget 510 is presented in the first widget 502. For example, the message presented in the illustrated second widget 510 may instead be presented as a second message in the first widget 502. Therefore, references to the second widget 510 should be understood as potentially applying to the first widget 502 instead. The second query widget 510 may indicate that at least one active offer was found. The second query widget 510 may prompt the user to provide additional information, which may include the user's address 512 or other identifying information, for example an e-mail address, social security number, etc. In an embodiment, if the database indicates that there is more than one match, a message may be displayed that indicates that it is unclear if an active offer was found. The widget 510 may further prompt the user to provide additional information to determine if there is a valid uniquely matched active offer for the user.

In some embodiments, the additional information provided by the user may be sent, by the user terminal, to the first server and/or the second server. The first server and/or second server may send an additional inquiry to the data store to determine if the additional information matches stored data records.

At decision block 425, the process 400 involves determining whether the additional information provided by the user at the second query widget 510 matches at least one active offer based on the stored data records. For example, the additional information may be compared to information associated with the active offers located at block 415. The first server and/or second server may send an additional inquiry (e.g., an API request) including the additional information to a server and/or database (e.g., credit records database 125 and/or consumer credit server 130, FIG. 1). The database may perform a search to determine if the additional information included in the inquiry matches any active offers based on the stored data records. If the additional information matches at least one active offer, the process 400 continues to block 450 in FIG. 4D. If the additional information does not match any active offers, the process 400 continues to block 440 in FIG. 4C.

At block 430 (FIG. 4B), the process 400 involves displaying a non-approval widget message 520 on the user interface. The non-approval widget 520 may indicate that an active offer was not found for the user. The non-approval widget 520 may prompt the user to provide additional information for determining whether the user pre-qualifies for an offer or may provide an icon 522 which, when selected, may facilitate routing the user to a pre-qualification data entry page 524 to provide more information about pre-qualification.

At block 435, the process 400 involves displaying a pre-qualification data entry page 524. The pre-qualification data entry page 524 may be a widget, web page, or mobile application and may allow users to pre-qualify or apply for and/or learn more about an offer. The pre-qualification data entry page 524 may be displayed in response to a user selecting the icon 522 via a user terminal.

In some embodiments, the non-approval widget 520 and the data entry page 524 may be combined into a single widget and/or page. The combined widget and/or page may indicate that an active offer was not found and may also allow users to apply for and/or learn more about an offer. Accordingly, blocks 430 and 435 may be combined to a single block for displaying the combined widget and/or page.

At block 440 (FIG. 4C), the process 400 involves displaying a non-verification widget message 526 in the user interface. The non-verification widget 526 may prompt the user to select an application icon 528 to be routed to the pre-qualification data entry page 524 to pre-qualify for an offer.

At block 445, the process 400 involves displaying the pre-qualification data entry page 524.

In some embodiments, the non-verification widget message 526 and the data entry page 524 may be combined into a single widget and/or page. The combined widget and/or page may indicate that an offer could not be verified and may also allow users to apply for and/or learn more about a pre-qualification offer. Accordingly, blocks 435 and 440 may be combined to a single block for displaying the combined widget and/or page.

At block 450 (FIG. 4D), the process 400 involves displaying an offer presentment page 514 including an approval code 516 in the user interface. The page 514 may be a widget, a web page of a website, or a mobile application page and may allow users to accept terms and conditions related to an offer. The approval page 514 may be generated and transmitted to a user terminal by the first server or second server. The approval page 514 may include an acceptance icon 517 which, when selected, facilitates routing the user to an acceptance page 518.

At block 455, the process 400 involves displaying an offer acceptance page 518. In some embodiments, the offer acceptance page 518 may have one or more fields for receiving data entries from the user. The acceptance page 518 may be a widget, web page, or mobile application page and may allow users to accept an offer using the approval code 516. The acceptance page 518 may be displayed in response to a user selecting the acceptance icon 516 via a user terminal.

### Offer Location via Link

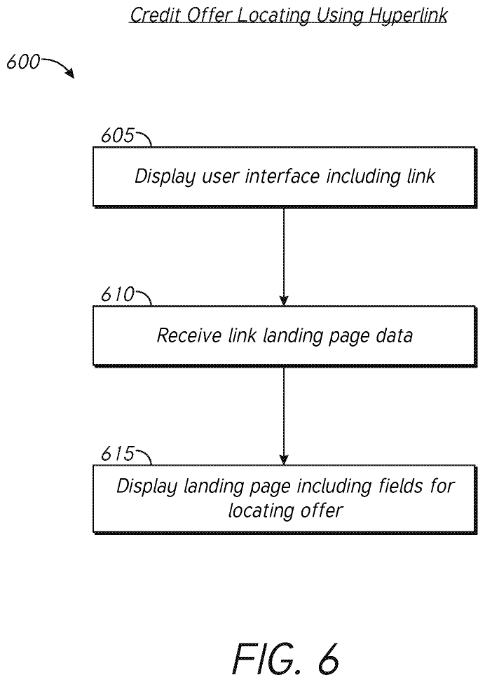

FIG. 6 is a flow diagram illustrating a process 600 for determining offer eligibility through use of a link to a landing page in accordance with one or more embodiments of the present disclosure.

At block 605, the process 600 involves displaying a user interface including a hyperlink to a landing page. The user interface may be a web page of a website, a mobile application, or web application. In some embodiments, the hyperlink may be included in a website directed to personal finance. The hyperlink may, when selected, facilitate routing users to a landing page for locating and/or applying for an offer.

At block 610, the process 600 involves displaying a landing page. The landing page may be a web page of a different website or a different mobile application than the website or mobile application including the hyperlink. The landing page may include various prompts and fields for receiving user input. User input received at the landing page may be implemented as described in FIGS. 3, 4 and 5, herein. That is, user input received at the landing page may be implemented for determining if users have been pre-approved for offers, locating offers, and facilitating applications for offers, and pre-qualifying for offers.

Other Offer Location Processes

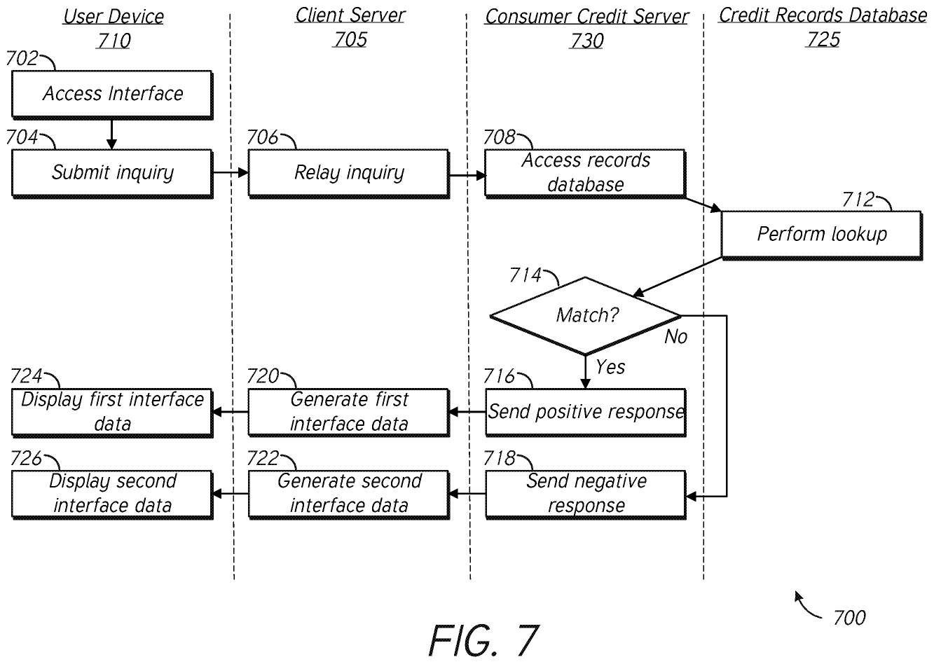

FIG. 7 is a flow diagram 700 illustrating a process for submitting and managing offer inquiries. At block 702, a user terminal 710 (e.g., a smartphone, laptop, desktop computer, tablet, kiosk, wearable computing device, or the like) may access a first interface hosted by a client server 705 (e.g., the client server 105 or affiliate server 120 of FIG. 1). The first interface may include various prompts, links, multimedia content, text fields, and/or other features to facilitate users in generating offer inquiries. In some embodiments, the first interface may comprise a control element such as a widget that comprises at least some of the features of the first interface.

At block 704, the user terminal 710 may submit an offer inquiry to the client server 705. The offer inquiry may be submitted in response to a user input at the user terminal 710. In some embodiments, the offer inquiry may comprise various data (e.g., name, address, social security number) provided to the user terminal 710 via one or more user inputs. In certain embodiments, the client server 705 and/or consumer credit server 730 may comprise a load balancer or other device configured to balance a load associated with the offer inquiry and/or other operations.

In some embodiments, offer inquiries may be sent to the client server 705 from an external server (e.g., from the affiliate server 120 to the client server 105 of FIG. 1). For example, an external server may host a website that users may access to prepare and send offer inquiries. In some embodiments, only offer inquiries from pre-determined sources may submit inquiries to the client server 705. For example, the client server 705 may store a list of approved partners from which the client server 705 may accept offer inquiries. In some embodiments, only offer inquiries submitted via an approved gateway may be received at the client server 705. For example, inquiries from partner sources may be required to be submitted through a particular API gateway.

At block 706, the client server 705 may relay the offer inquiry to the consumer credit server 730 (e.g., the consumer credit server 130 in FIG. 1). In some embodiments, the client server 705 may store at least some data included in the offer inquiry in internal and/or external storage. For example, the client server 705 may store user profile information (e.g., name, address, social security number) included in the offer inquiry. In some embodiments, the client server 105 may encrypt at least some data of the offer inquiry before relaying the offer inquiry to the consumer credit server 730.

At block 708, the consumer credit server 730 submits a request to a credit records database 725 (e.g., the credit records database 125 of FIG. 1) to request a search using data included in the offer inquiry. In some embodiments, the consumer credit server 730 may access stored data related to the client server 705 and include the stored data in the request. For example, the client server 705 may be operated by a lending institution with particular criteria for issuing lending offers. In response to receiving the offer inquiry from the client server 705, the consumer credit server 730 may access data indicative of the particular criteria which may be stored at the consumer credit server 730 and/or an external database.

At block 712, the credit records database 725 performs a lookup function to determine if information included in the request matches stored credit records. For example, the credit records database 725 may store lists (e.g., a direct mail list) comprising identifiers of users who satisfy criteria of various entities (e.g., the lending institution associated with the client server 705).

At decision block 714, the consumer credit server 730 determines, based on the lookup function, whether the user information included in the offer inquiry matches the credit records.

At block 716, in response to a positive match indication, the consumer credit server 705 may send a positive response to the client server 705. In some embodiments, the positive response may include various offer identification data, for example a reservation number and/or a product code. At block 718, in response to a negative match indication, the consumer credit server 705 may send a negative response to the client server 705.

At block 720, in response to the positive response, the client server 705 may generate and transmit first interface data to the user terminal 710. In some embodiments, the first interface data may comprise text and/or multimedia content indicating that an offer was confirmed and prompting the user to accept the offer. The first interface data may further comprise a link to an acceptance page and/or fields for accepting user input pursuant to accepting the offer. In some embodiments, the first interface data may include various offer identification data, for example the reservation number and/or product code.

At block 722, in response to the negative response, the client server 705 may generate and transmit second interface data to the user terminal 710. In some embodiments, the second interface data may comprise text and/or multimedia content indicating that an offer was not found and/or prompting the user to apply for a different offer (e.g., a pre-qualification offer). At block 724, the user terminal 710 may display the first interface data. At block 726, the user terminal 710 may display the second interface data.

In some embodiments, users may submit inquiries via an interactive voice response (IVR) system, chatbot, and/or a smart voice controller (e.g., a Google Home device). For example, a user may call a phone number through use of a user terminal (e.g., user terminal 110 in FIG. 1). In some embodiments, the phone number may be provided to the user in an interface provided by a client server (e.g., the client server 105 in FIG. 1). The user may provide various personal information (e.g., the user's name, address, partial social security number) via voice and/or text input to the IVR system, and/or the user's personal information could be provided to the IVR system after being retrieved from a smart speaker device account (e.g., a Google account associated with the user) and/or an external database linked to a smart speaker device (e.g., a Google Home device belonging to the user). In some embodiments, an IVR or similar system may be hosted by the client server 125 and/or affiliate server 120 of FIG. 1. Accordingly, user input received via an IVR or similar system may be used to generate inquiries and/or perform lookup functions similar to those described above with respect to widget and/or API implementations. In some embodiments, terms, conditions, and/or other information associated with an offer may be provided to the user in an audible form via an IVR or similar system, email, and/or short message service (SMS) message.

### Fraud Prevention

Some embodiments may include systems and/or methods for preventing fraudulent actions. In certain embodiments, certain actions may be restricted based on a user's geographic location. For example, users outside the United States and/or a different country may be restricted from locating offers.

In certain embodiments, a number of requests may be restricted for a given device and/or during a given period of time. For example, an Internet Protocol (IP) address and/or data of an incoming request may be collected. The IP address may be entered into a data store (e.g., a redis cache) along with a counter to keep track of a number of attempts by a particular device associated with the IP address. A Time-To-Live (TTL) may also be set for the IP address. Once the TTL expires, the data store may automatically remove the IP address. If an IP address is already present in the data store, the counter value may be compared with a value set for a maximum number of requests. If the counter value is less than a maximum number of requests, then the counter value may be incremented. If the counter value is greater than the maximum number of requests, then the request from that particular IP address may be blocked for a period of time (e.g., 24 hours).

For example, a maximum number of requests may be set to three and a TTL may be set to 24 hours. The maximum number and/or TTL period may be adjustable. If a request is blocked, the data store may store a record indicating that the IP address may be associated with fraudulent activity and the IP address may be used for analytics purposes.

In certain embodiments, requests may be blocked if a given number of identical requests are received over a period of time. In some embodiments, a user's identifying information (e.g., first name and/or last name) may be collected from an incoming request initiated by the user. The collected information (which may be concatenated to form a single string) may be entered into data store. A counter and/or a TTL may be added to the data store as well to keep track of a number of attempts. For example, the TTL may be set to one hour so that only requests received during a period of one hour are reflected in the counter value. If the collected information is already present in the data store, the counter value may be compared with a value set for a maximum number of attempts (e.g., 10). If the counter value is less than or equal to the maximum number of attempts, the counter value may be incremented. If the counter value is greater than the maximum number of attempts, the request may be blocked for a period of time (e.g., one hour). In certain embodiments, if a request is blocked, an interface may be displayed which indicates that an offer was not found for the user.

### Additional Embodiments

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

The headings provided herein are for convenience only and do not necessarily affect the scope or meaning of the claims. Disclosed herein are example configurations and embodiments relating to user interfaces and transmitting data between computing systems.

Particular aspects of the present disclosure are described herein with reference to the drawings. In the present disclosure, common features may be designated by common reference numbers. Although certain examples are described herein with reference to a data storage device, it should be appreciated that techniques described herein are applicable to other implementations. Furthermore, it is to be appreciated that certain ordinal terms (e.g., “first” or “second”) may be provided for ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to any other element, but rather may generally distinguish the element from another element having a same name (but for use of the ordinal term). In addition, as used herein, indefinite articles (“a” and “an”) may indicate “one or more” rather than “one.” Further, an operation performed “based on” a condition or event may also be performed based on one or more other conditions or events not explicitly recited. As used herein, “exemplary” may indicate an example, an implementation, and/or an aspect, and should not be construed as limiting or as indicating a preference or a preferred example, implementation, and/or aspect.

Although certain embodiments are disclosed herein in the context of solid-state data storage devices and systems, it should be understood that certain features disclosed herein may be applicable devices/systems incorporating one or more other types of data storage, such as magnetic media, or other volatile or nonvolatile memory. As used in this application, “nonvolatile solid-state memory,” “nonvolatile memory,” “NVM,” or variations thereof may refer to solid-state memory such as NAND flash. However, the systems and methods of this disclosure may also be useful in more conventional hard drives and hybrid drives including both solid-state and hard drive components. Solid-state memory may comprise a wide variety of technologies, such as flash integrated circuits, Phase Change Memory (PC-RAM or PRAM), Programmable Metallization Cell RAM (PMC-RAM or PMCm), Ovonic Unified Memory (OUM), Resistance RAM (RRAM), NAND memory, NOR memory, EEPROM, Ferroelectric Memory (FeRAM), MRAM, or other discrete NVM (nonvolatile solid-state memory) chips. The nonvolatile solid-state memory arrays or storage devices may be physically divided into planes, blocks, pages, and sectors, as is known in the art. Other forms of storage (e.g., battery backed-up volatile DRAM or SRAM devices, magnetic disk drives, etc.) may additionally or alternatively be used.

Those skilled in the art will appreciate that in some embodiments, other communication systems and/or methods of locating and facilitating application for credit offers can be implemented. In addition, the actual steps taken in the processes discussed herein may differ from those described or shown in the figures. Depending on the embodiment, certain of the steps described above may be removed, others may be added.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Methods and processes described herein may be embodied in, and partially or fully automated via, software code modules executed by one or more general and/or special purpose computers. The word “module” may refer to logic embodied in hardware and/or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). “Module” may further refer to one or more devices, components, systems, or subsystems, which may conceptually implement relevant functionality. It will be further appreciated that hardware modules may be comprised of connected logic units, such as gates and flip-flops, and/or may be comprised of programmable units, such as programmable gate arrays, application specific integrated circuits, and/or processors. The modules described herein are preferably implemented as software modules, but may be represented in hardware and/or firmware. Moreover, although in some embodiments a module may be separately compiled, in other embodiments a module may represent a subset of instructions of a separately compiled program, and may not have an interface available to other logical program units.

What is claimed is:

1. A system comprising:
a communication circuit configured to communicate over a communication network;
a memory; and
control circuitry configured to:
generate first interface data, the first interface data comprising a first widget configured to receive user information;
providing, using the communication circuit, the first interface data to a remote computing terminal;
receive, via the first widget, a first set of user information from the remote computing terminal;
generate a first result via comparing the first set of user information to a list of users who have been pre-approved to receive an offer;
generate second interface data, the second interface data comprising a second widget including an indication of the first result; and
providing, using the communication circuit, the second interface data to the remote computing terminal.

2. The system of claim 1, wherein the list of users is stored in the memory.

3. The system of claim 1, wherein the control circuitry is further configured to:
generate an application programming interface (API) request based on the received user information; and
send the API request to a remote data store, wherein the list of users is stored in the remote data store.

4. The system of claim 1, wherein the control circuitry is further configured to:
obtain a set of criteria for identifying pre-approved candidates; and
generate a list of users who have been pre-approved for the offer based on the received set of criteria.

5. The system of claim 1, wherein the first set of user information comprises one or more of a name and a social security number.

6. The system of claim 1, wherein:
the first result is indicative of a positive match;
the second widget comprises one or more fields for collecting a second set of user information.

7. The system of claim 6, wherein:
the control circuitry is further configured to receive, via the second widget, the second set of user information; and
the second set of user information comprises one or more of a name, residential address, e-mail address, and social security number.

8. The system of claim 7, wherein the control circuitry is further configured to:
generate a second result via comparing the second set of personal user information to stored user information;
generate third interface data, the third interface data comprising a third widget including an indication of the second result; and
providing the third interface data to the remote computing terminal.

9. The system of claim 1, wherein the second interface data comprises a hyperlink to one of a first web page for facilitating acceptance of the offer and a second web page for facilitating an application process for a second offer.

10. The system of claim 1, wherein the control circuitry is further configured to:
generate a fraud result based on one or more of a location associated with the first interface data, an internet protocol (IP) address associated with the first interface data, and a determination that the first interface data is identical to one or more previously received interface data sets; and
generate the second interface data, the second interface data comprising a second widget indicating that an offer was not found.

11. A method for locating offers, comprising:
providing a first interface for operation at a remote computing terminal over a communication network, the first interface comprising a first widget configured to receive personal user information;
receiving, via the first interface, a first set of user information;
generating a first result via comparing the first set of user information to a list of users who have been pre-approved to receive an offer; and
providing a second interface for operation at the remote computing terminal over the communication network, the second interface comprising a second widget including an indication of the first result.

12. The method of claim 11, wherein the method further comprises:
generating an application programming interface (API) request based on the first set of personal user information; and
sending the API request to a remote data store, wherein the list of users is stored in the remote data store.

13. The method of claim 11, wherein the method further comprises:
obtaining a set of criteria for identifying pre-approved candidates; and
generating a list of users who have been pre-approved for the offer based on the received set of criteria.

14. The method of claim 11, wherein:
the first result is indicative of a positive match;
the second widget comprises one or more fields for collecting a second set of user information.

15. The method of claim 14, further comprising receiving, via the second widget, the second set of user information, wherein the second set of user information comprises one or more of a name, residential address, e-mail address, and social security number.

16. The method of claim 15, further comprising:
generating a second result via comparing the second set of user information to stored user information; and
generating a third interface for operation at the remote computing terminal over the communication network, the third interface data comprising a third widget including an indication of the second result.

17. An apparatus for locating pre-approved offers of credit, the apparatus comprising:
a network interface; and
control circuitry configured to:
obtain, via the network interface, a first inquiry comprising a first set of user information and an indication of a first offer;
transmit, via the network interface, a second inquiry comprising the first set of user information, the indication of the first offer, and a request to access stored user records;
obtain, via the network interface, an indication of a first result based on a comparison of the first set of user information to a list of users who have been pre-approved for the first offer; and
generate result data comprising an indication of the first result.

18. The apparatus of claim 17, wherein the result data comprises a graphical interface comprising a widget including the indication of the first result.

19. The apparatus of claim 17, wherein the result data comprises audio data.

20. The apparatus of claim 17, wherein the first inquiry comprises audio data received from an interactive voice response (IVR) system, chatbot, or smart voice controller.

21. The apparatus of claim 17, wherein the control circuitry is further configured to:
generate an application programming interface (API) request based on the first set of user information; and
transmit the API request to a remote data store, wherein the list of users is stored in the remote data store, and wherein the indication of the first result is obtained from the remote data store.

22. The apparatus of claim 17, wherein the control circuitry is further configured to:
obtain a set of criteria for identifying pre-approved candidates; and
generate a list of users who have been pre-approved for the offer based on the received set of criteria.

23. The apparatus of claim 17, wherein the first set of user information comprises one or more of a name and a social security number.
